(19) United States
(12) Patent Application Publication
(10) Pub. No.: US 2016/0319414 A1
(43) Pub. Date: Nov. 3, 2016

(54) Poly (Acrylic Acid) Modified Cellulose Fiber Materials

(71) Applicant: Case Western Reserve University, Cleveland, OH (US)

(72) Inventors: Anne Walker, Cleveland, OH (US); Gary E. Wnek, Cleveland, OH (US)

(73) Assignee: Case Western Reserve University, Cleveland, OH (US)

(21) Appl. No.: 15/141,747

(22) Filed: Apr. 28, 2016

Related U.S. Application Data
(60) Provisional application No. 62/153,900, filed on Apr. 28, 2015.

(51) Int. Cl. C23C 2/00; C09D 133/02

(52) U.S. Cl. CPC C23C 2/00; C09D 133/02

(57) ABSTRACT

In one embodiment, PAA is immobilized on dry, solid, fibrous media, such as cellulose fiber paper (“PAA-CF”) to yield a robust, flexible material with substantial wicking and fluid uptake capabilities. PAA-CF materials demonstrate the ability for use as collection and storage devices for applications such as dried blood spot analysis, protein and DNA preservation and analysis, enzymatic assays, biomarker identification, and other processes used for biological materials. PAA-CF materials can readily take up whole blood, plasma, proteins, and solutions of molecules that can then be easily extracted and analyzed.

### RELATED APPLICATION

This application claims priority to U.S. Provisional Patent Application Ser. No. 62/153,900, titled “Poly(acrylic acid) Modified Cellulose Fiber Materials,” which was filed on Apr. 28, 2015, which is expressly incorporated by reference herein in its entirety.

### FIELD OF INVENTION

The present disclosure generally relates to the formation of poly(acrylic acid)-modified fibrous materials. More specifically, the present disclosure relates to the formation of poly(acrylic acid)-modified fibrous materials for use in the collection and storage of biological materials.

### BACKGROUND

One common function of clinicians and researchers in the medical field is the preparation and analysis of biological materials such as biological fluids and tissue. The collection and storage of biological materials can be problematic and error prone. Often it is necessary to store biological materials in a cold environment and away from light. Thus, storage of large volumes of biological material samples can be resource-intensive. If proper storage conditions are not met or unavailable, rapid degradation of the biological material samples may be unavoidable. Furthermore, certain facilities are not equipped with their own analysis equipment and, thus, must ship biological material samples to other locations or third parties. Such shipping of biological materials can add additional steps and complexity to the process and can increase the opportunity for degradation and administrative errors. A reduction in the quantity of biological material required for analysis and simplification of the storage requirements of biological material remain critical issues. Thus, there is a need for inexpensive, portable biological material analysis systems for use by clinicians and researchers.

### BRIEF DESCRIPTION OF THE DRAWINGS

In the accompanying drawings, information is illustrated that, together with the detailed description provided below, describe example embodiments of the claimed invention. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 is an image representing blood spotted onto plain, unmodified cellulose fiber chromatography paper.

FIG. 2 is an image representing blood spotted onto various materials.

FIG. 3 is an image illustrated test results.

FIG. 4 is an image of a chart showing test results.

FIG. 5 is an image of a chart showing test results.

### SUMMARY

Poly(acrylic acid) (to be referred to herein as “PAA”) is an anionic polyelectrolyte. When PAA is cross-linked, PAA can be water-insoluble and can form stable biocompatible hydrogels with a physiological pH (i.e., a pH that is approximately the pH of blood, which typically has a slightly basic pH of about 7.365). Such characteristics are particularly common when PAA is lightly cross-linked.

In one embodiment, PAA can be immobilized on dry, solid, fibrous media, such as cellulose fiber paper to yield a robust, flexible material with substantial wicking and fluid uptake capabilities. The material resulting from such a process will be generally referred to as “PAA-CF” throughout this disclosure. PAA-CF materials demonstrate the potential for use as collection and storage devices for applications such as dried blood spot analysis, protein and DNA preservation and analysis, enzymatic assays, and biomarker identification. PAA-CF materials can readily take up whole blood, plasma, proteins, and solutions of molecules that can then be easily extracted and analyzed.

### DETAILED DESCRIPTION

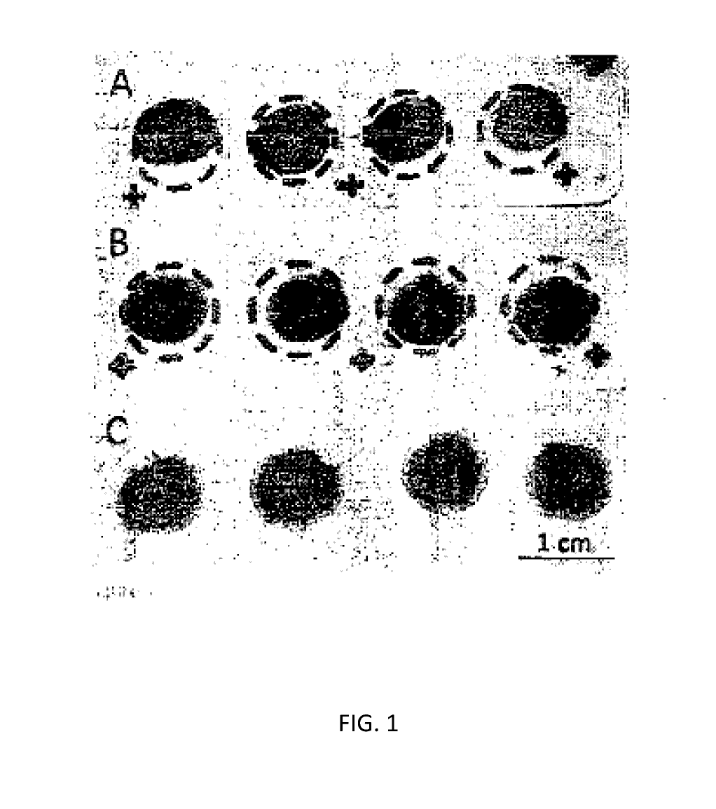

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of apparatus, arrangements, and methods for the formation of poly(acrylic acid)-modified fibrous materials are hereinafter disclosed and described in detail with reference made to FIGS. 1-5.

One example of a technique used to manage biological fluid samples is Dried Blood Spot (DBS) analysis. In the DBS method, typically several microliters of blood are collected from a subject and allowed to dry onto a fibrous matrix that can contain several additional small molecules. This resulting material can be stored at room temperature and relatively easily transported. DBS analysis can be an alternative to venipuncture. Elimination of the need to process large volumes of blood can be incredibly beneficial in improving the availability of blood analysis to clinics, field hospitals, and research laboratories. However, the benefits of the DBS process are counterbalanced by the ineffectiveness of the analysis of large molecules such as biomarkers, proteins, and drugs. Also, the nature of many of the existing blood and biological fluid collection products prohibits the use of a number of common large molecule analysis techniques.

Currently, FTA-DMPK blood analysis cards and the 903 Neonatal Screening cards produced by GE Healthcare are the industry standard for biological fluid collection, and generally require the use of 10-20 microliters of biological fluid. These materials are essentially cellulose fiber paper impregnated with a variety of small molecules, such as sodium dodecyl sulfate (SDS) and ethylenediaminetetraacetic acid (EDTA) to impart functionality. While these molecules may help preserve stored biological material, they greatly limit the analysis techniques that can be employed.

Matrix-assisted laser desorption/ionization (MALDI) is one such technique that is rendered unusable, as the introduction small molecules can lead to signal suppression. This phenomenon is not limited to MALDI, as techniques such as high performance liquid chromatography-mass spectrometry (HPLC-MS) and gas chromatography-mass spectrometry (GC-MS) also exhibit signal suppression in the presence of small molecules. Additionally, small molecules can interfere with common protein quantification techniques in a variety of ways. For example, the Bradford Assay is sensitive to SDS contamination and UV-Spectrophotometric quantification assays are sensitive to a variety of organic compounds.

An alternative method to using small molecules to improve the functionality of fibrous biological fluid collection materials is to immobilize cross-linked poly(acrylic acid) (PAA) onto a fiber matrix. PAA can readily form hydrogels and can exhibit outstanding fluid uptake properties. In addition, synthesis of PAA is relatively straightforward and the general composition of the material can be modified both during and after synthesis to affect the desired functionality. PAA acts as a chelator and PAA can have an especially high affinity for iron chelation, which can be of benefit to blood analysis applications. Additionally, PAA can be tailored during synthesis, enabling the addition of functional groups that can, for example, act as cell wall lysis agents or serve to selectively bind and release molecules of interest. Properties such as this can eliminate the need for additional small molecules, clearing the path for use of techniques like MALDI and UV Spectrophotometry. Disclosed herein are methods for the formation of poly(acrylic acid)-modified fibrous materials for use in the collection and storage of biological materials.

One method of forming a PAA-CF material is to prepare a formulation of PAA from acrylic acid. In one example, the formulation can be acrylic acid, 5 mM N′,N′-methylene bisacrylamide, 3 mM potassium persulfate, and 2.2 M sodium hydroxide. Such a formulation can yield a prepolymer solution with a viscosity slightly higher than water. Additionally, the amount of base such as sodium hydroxide can be varied to suit specific applications, as different amounts can influence material swelling and fluid uptake. Such a prepolymer solution is stable and will not polymerize until exposed to heat. Once the PAA prepolymer is mixed, sheets of fibrous material, such as cellulose fiber chromatography paper, can be dipped into the prepolymer solution. In one embodiment, the sheets can be allowed to soak for ten minutes while on an orbital shaker. The materials can be removed and excess prepolymer lightly blotted off. The sheets can then be placed in an oven at 80° C. for 60 minutes to polymerize the impregnated prepolymer solution. Once polymerized, the materials can be removed from the oven and allowed to sit at room temperature for 24 hours to ensure that the reaction has reached completion. Materials can then be washed twice in distilled water and allowed to dry.

Another exemplary method for fabricating PAA-CF material is to modify the PAA backbone with a UV-reactive group and use UV light to induce crosslinking. Examples of materials that can be crosslinked to PAA would be epoxy-containing molecules such as glycidol or highly reactive materials such as 4-hydroxybenzophenone. Examples of crosslinking agents would be diaryl iodonium salts. These materials can be impregnated into the fiber matrix then crosslinked using either shortwave or longwave UV light, depending on the particular formulation of side group and crosslinking agent.

To test the resulting PAA-CF material, the PAA-CF material can be used in dried blood spot testing and compared to conventional materials. In one example, 15 microliters of human blood was spotted onto GE FTA-DMPK A and B cards, as well as on the PAA-CF materials. After fourteen days of storage in a dark, dry container, the centers of the blood spots on each material was punched out using a 5 mm biopsy punch, brought up in 200 microliters of distilled water, and vortexed for ten minutes. Then 45 microliters of the supernatant was drawn from each sample and combined with 15 microliters of water and 1 microliters of sample buffer. This process was used to test 20 microliters and 10 microliters samples using a NuPAGE Novex 4-12% bis-tris protein gel.

The results were as follows. The blood spotted onto the FTA-DMPK A cards darkens slowly as it dried and appeared to stratify less than the blood on the FTA-DMPK B card. Blood spotted onto the FTA-DMPK B cards rapidly darkened and a slight halo forms as the plasma and hematocrit portions of the whole blood separated slightly. The blood spotted onto the PAA-CF material did not immediately dry and it stratifies so that the separate plasma and hematocrit portions can easily be identified. Blood spotted onto plain, unmodified cellulose fiber chromatography paper was also used as a control. Blood spotted onto this material exhibited no stratification. An example is illustrated in FIG. 1.

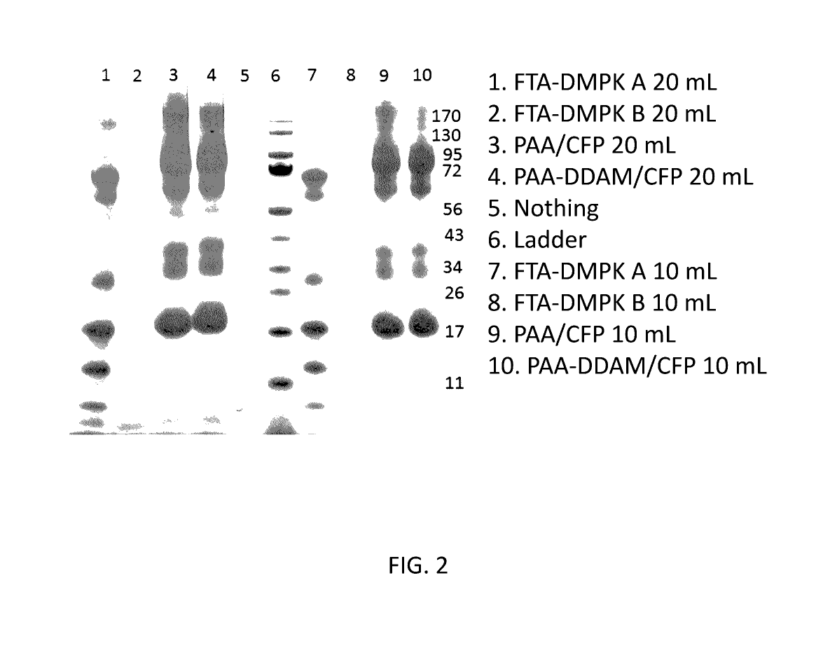

SDS-PAGE of the eluate collected from these materials showed a dramatic increase in the quantity of protein present in the sample collected from the PAA-CF materials as compared to that of the FTA-DMPK A and B materials. These results indicate the capabilities and functionality of the PAA-CF materials, as they exhibit a high degree of protein reporting with very small quantities of blood. The materials of interest can also be extracted using only water, rather than with lengthy organic solvent extraction procedures as is required with the FTA-DMPK materials. FIG. 2 further illustrates results. FIG. 2 includes a legend to identify the ten samples.

A related follow-up experiment to the one described above uses two formulations of the PAA-CF material: one with the regular amount of sodium hydroxide (2.2 M, termed PAA-CFA) and one with no sodium hydroxide (termed PAA-CFB). For this assay, FTA-DMPK A, B, and C cards, plain cellulose fiber chromatography paper (CFP), and PAA-CF materials can be used. Each card is spotted with 15 uL of human blood. Circles measuring 5 mm are punched from each spotted card as well as from unspotted cards to serve as a control. Samples can then brought up in 250 uL of distilled, deionized water and agitated for ten minutes to facilitate extraction. For this assay, 10 uL of each sample was then mixed with 2 uL of NuPAGE LDS sample buffer, 1 uL of 0.5 M dithiothreitol, and 7 uL of water. Samples were held for 10 minutes at 70° C., and then allowed to come to room temperature and loaded onto the gel.

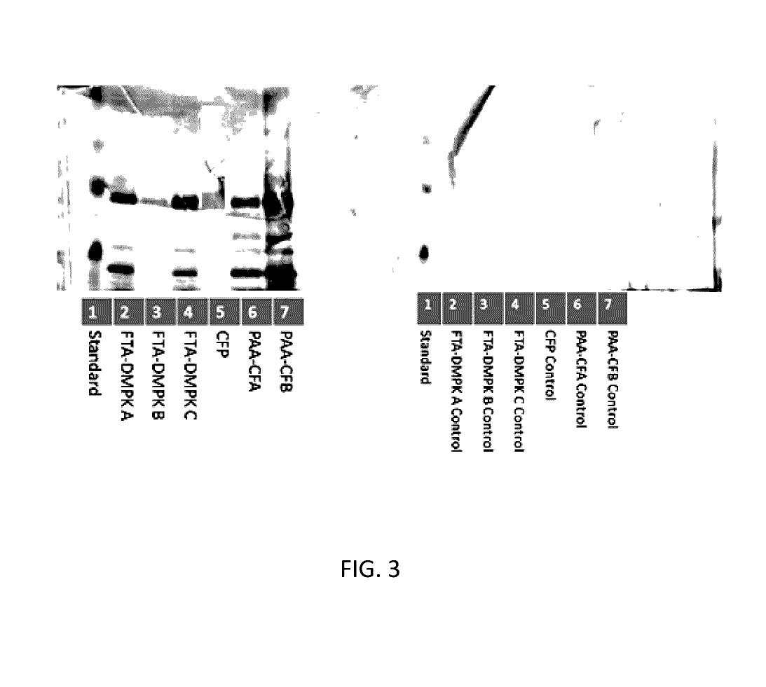

Overall, extracts from PAA-CFB showed the highest signal. It does not appear that any protein bands are lost between any of the materials, except in the case of the cellulose fiber sample. Of the commercially-available materials, it appears as though FTA DMPK C shows the greatest signal, followed by FTA DMPK A, with the extract from FTA DMPK B showing very little extraction overall. FIG. 3 further illustrates results. FIG. 3 includes a legend to identify the samples.

In another example, the PAA-CF materials can be compared with commercially-available DBS materials such as the FTA-DMPK A, B, and C cards and analyzed using the well-known Bradford Assay, which relies on the shift of Coomassie Brilliant Blue dye from a red or green color to a blue color once protein has bound to the dye. The assay is highly sensitive to detergents, so the presence of SDS, such as is in the case of some of the FTA-DMPK cards. renders this assay very unreliable.

For this assay, A 5× Bradford reagent solution can be produced and diluted prior to use. 100 mg of Coomassie Brilliant Blue dye can be mixed with 47 mL of methanol and 100 mL of phosphoric acid , then brought up to 200 mL using distilled, deionized water. This solution can then be filtered. 10 uL of human blood can be spotted onto FTA-DMPK A, B, and C cards, as well as onto PAA-CF card and onto plain cellulose fiber chromatography paper. 5 mm samples can be punched from each card and incubated in 250 uL of distilled, deionized water for 10 minutes on a vortex mixer. 2 uL of each eluate can then be removed and incubated with 1 mL of Bradford reagent and allowed to stand for 5 minutes and then placed on a polystyrene cuvette and immediately analyzed using a spectrophotometer at 595 nm. The absorbance can be recorded and compared with a BSA calibration curve to quantify protein content of the sample. This process was used to test 10 uL of eluate from the FTA-DMPK A, B, and C cards, the PAA-CF material, and from plain cellulose chromatography paper.

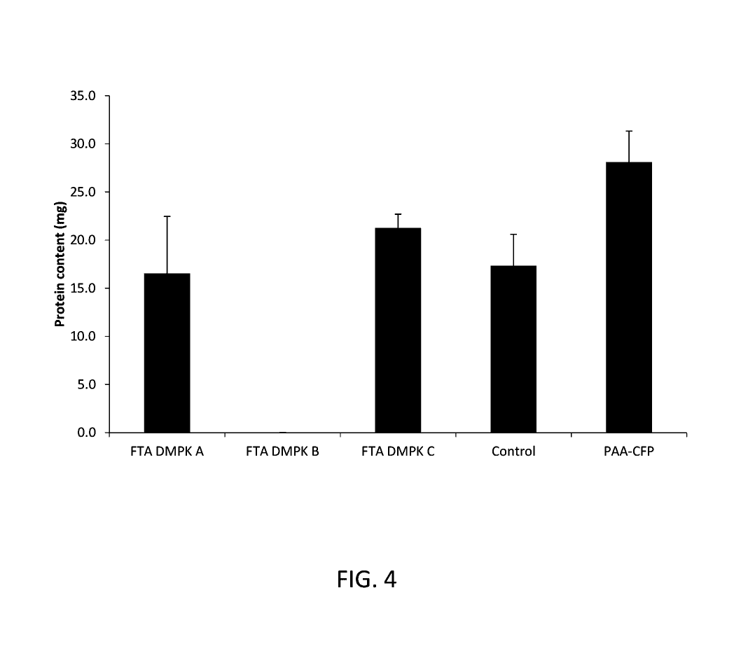

As illustrated in the graph illustrated in FIG. 4, overall, the PAA-CFP material showed the greatest amount of protein recovered, followed by the plain cellulose fiber chromatography paper and FTA-DMPK C materials. FTA-DMPK A showed less protein than all the other samples except for FTA-DMPK B, which showed no protein recovery at all. The possibility of using only water extraction for sample analysis is incredibly promising, and the high yield of the PAA-CFP as compared to the FTA-DMPK A card, and the fact that there is no yield from the FTA-DMPK B card demonstrates the improvement of this new technique.

Another assay commonly used in protein detection and quantification is the bicinchoninic acid (BCA) assay, which utilizes a copper reagent to induce a colormetric change that can be analyzed using a spectrophotomer. This assay is extremely sensitive to chelating agents such as EDTA, which can be found in some of the FTA-DMPK products. The BCA assay can be performed using commercially available kits, such as the Pierce BCA assay kit. For this kit, Standard Working Reagent (SWR) can be created fresh by mixing 1 part BCA Reagent B to 50 parts Reagent A, yielding a vibrant green solution that can then be used to analyze eluates from dried blood spot materials.

For this assay, FTA-DMPK A, B, and C cards, plain cellulose fiber chromatography paper (CFP), and PAA-CF materials can be used. 15 uL of human blood can be spotted onto each card. 5 mm circles can be punched from each spotted card as well as from unspotted cards to serve as a control. Samples can then brought up in 250 uL of distilled, deionized water and agitated for ten minutes to facilitate extraction. For this assay, 1 mL of SWR can be mixed with 20 uL of eluate from each of the different dried blood spot materials described above, and incubated at 60C for 30 minutes. In addition to whole blood, human plasma samples can be analyzed using the same general preparation as the blood samples described above. For this assay, after incubation, the eluate from each sample was allowed to cool to room temperature and analyzed on a spectrophotomer at 562 nm. This experiment was performed in triplicate and the absorbances averaged.

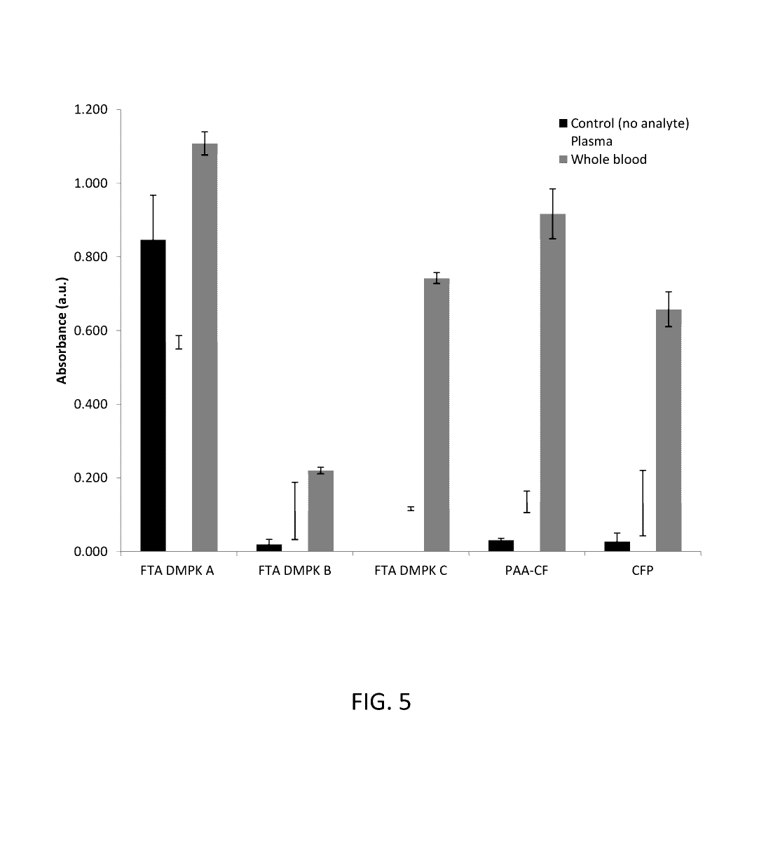

Significant signal was present in the FTA-DMPK A eluates, including in control samples. Given this, it is likely that one of the small molecules, likely EDTA, impregnated in the FTA-DMPK A card causes interference with the reagents used in the BCA assay. This renders any data from the FTA DMPK A card questionable, and it is therefore unsuitable for use with this assay. Overall, the signal from the extracted whole blood samples remained highest from the PAA-CF cards. The results here reinforce those found before using SDS-PAGE, with PAA-CF cards expressing higher overall protein yields when extracted using distilled, deionized water. FIG. 5 illustrates testing results.

When compared to other commercially-available products, numerous benefits or poly(acrylic acid) derivatives have been identified compared to the traditional combination of small molecules used in the FTA-DMPK products. First, the method by which the PAA is immobilized on the cellulose fiber papers is a straightforward, one-pot synthesis followed by adsorption onto commercially-available cellulose fiber filter paper, representing a simple technique that is amenable to scale-up. Molecular weight, crosslinking density, and overall pH and ionic environment can be tailored to suit specific applications without the need of small molecules. Overall, the PAA-CF materials fabricated as described herein demonstrates a great potential for application as a biological material collection and storage device. After two weeks of storage, it was still possible to extract and analyze proteins collected from a dried blood sample, and the PAA-CF materials could be used in conjunction with the very common Bradford and BCA protein assays.

Perhaps the greatest benefit of PAA, even beyond its inherent multifunctional behavior, is that it can be further enhanced by introducing new functionalities or architectures during synthesis and processing. For example, to improve cell lysis capabilities, copolymerizing poly(acrylic acid) and a medium-chain acrylamide, such as N-dodecylacrylamide can provide good results. The use of this copolymer has potential to yield much more efficient cell lysis and improve subsequent access to genetic material or proteins of interest; modifying the surface of the PAA-CF materials with long PAA brushes can improve protein binding capacities. Overall, PAA-CF materials show great promise in terms of functionality, stability, and versatility, and the material can easily be tailored to fit a wide range of needs for biological sampling and analysis.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A method for forming a material including:
prepare a formulation of poly(acrylic acid) from acrylic acid;
provide at least one portion of fibrous material;
place the at least one portion of fibrous material in the poly(acrylic acid); and
remove the at least one portion of fibrous material from the poly(acrylic acid).

2. The method of claim 1, further including removing excess poly(acrylic acid) from the at least one portion of fibrous material after the fibrous material is removed from the poly(acrylic acid).

3. The method of claim 1, where the at least one portion of fibrous material in placed in the poly(acrylic acid) for approximately ten minutes.

4. The method of claim 1, wherein the formulation of poly(acrylic acid) from acrylic acid further includes N′,N′-methylene bisacrylamide, potassium persulfate, and sodium hydroxide.

5. The method of claim 4, wherein the formulation includes 5 mM N′,N′-methylene bisacrylamide, 3 mM potassium persulfate, and 2.2 M sodium hydroxide.

6. The method of claim 1, wherein the fibrous material is cellulose fiber chromatography paper.

7. The method of 1, wherein after the fibrous material is removed from the poly(acrylic acid), the fibrous material is impregnated with poly(acrylic acid).

8. The method of claim 7, wherein fibrous material impregnated with poly(acrylic acid) is exposed to heat.

9. The method of claim 8, wherein the exposure to heat includes exposure to an environment of approximately 80° C. for approximately 60 minutes.

10. The method of claim 9, wherein after the exposure to heat, fibrous material impregnated with poly(acrylic acid) is exposed to an ambient temperature for approximately 24 hours.

11. The method of claim 9, wherein the exposure to heat and ambient temperature polymerizes the poly(acrylic acid).

12. The method of claim 1, wherein the backbone of the poly(acrylic acid) is modified with a UV-reactive group.

13. The method of clam 12, wherein UV light is applied to induce crosslinking.

14. The method of claim 12, wherein the UV-reactive group is an epoxy-containing molecule.

15. The method of claim 14, wherein the epoxy-containing molecule is glycidol.

16. The method of claim 14, wherein the epoxy-containing molecule is 4-hydroxybenzophenone.

17. The method of claim 13, wherein a crosslinking agent is used.

18. The method of claim 17, wherein the crosslinking agent is a diaryl iodonium salt.
